(19) United States
(12) Patent Application Publication
(10) Pub. No.: US 2014/0261951 A1
(43) Pub. Date: Sep. 18, 2014

(54) TIRE COMPRISING A LAYER OF CIRCUMFERENTIAL REINFORCING ELEMENTS

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Alain Domingo, Clermont-Ferrand (FR); Jacques Besson, Clermont-Ferrand (FR); François Barbarin, Clermont-Ferrand (FR); Gilles Sallaz, Clermont-Ferrand (FR); Robert Ciprian Radulescu, Clermont-Ferrand (FR)

(73) Assignees: COMPAGNIE GENERALE DES ETABLISSEMENTS MICHELIN, Clemont-Ferrand (FR); MICHELIN RECHERCHE ET TECHNIQUE S.A., Granges-Paccot (CH)

(21) Appl. No.: 14/351,820

(22) PCT Filed: Oct. 12, 2012
(86) PCT No.: PCT/EP2012/070241

§ 371 Date: Apr. 14, 2014

(30) Foreign Application Priority Data
Oct. 13, 2011 (FR) 1159244

(51) Int. Cl. B60C 9/20

(52) U.S. Cl. CPC B60C 9/20; B60C 2009/2051; B60C 2009/2016; B60C 2009/2019
USPC 152/527

(57) ABSTRACT

A tire having a crown reinforcement formed of at least two working crown layers each formed of reinforcing elements inserted between two calendaring layers of rubber compound, crossed from one layer to the other making angles of between 10° and 45° with the circumferential direction and the crown reinforcements comprising at least one layer of circumferential reinforcing elements. The elastic modulus under 10% tensile strain of at least one calendaring layer of at least one working crown layer is less than 8.5 MPa and the maximum value of tan(δ), denoted tan(δ)max, of said at least one calendaring layer of at least one working crown layer is less than 0.100.

This application claims benefit of the filing date of PCT/EP2012/070241, filed Oct. 12, 2012, which claims the benefit of FR1159244, filed Oct. 13, 2011, the entire contents of each of which are incorporated herein by reference for all purposes.

### BACKGROUND

1. Field

Disclosed herein is a tire having a radial carcass reinforcement and more particularly to a tire intended to equip vehicles carrying heavy loads and running at sustained speed, such as, for example, lorries, tractors, trailers or buses.

2. Description of Related Art

Generally, in the tires of heavy-duty type, the carcass reinforcement is anchored on either side in the region of the bead and is surmounted radially by a crown reinforcement composed of at least two superimposed layers formed of threads or cords which are parallel in each layer and crossed from one layer to the next, forming angles of between 10° and 45° with the circumferential direction. The said working layers, forming the working reinforcement, can also be covered with at least one “protective” layer formed of reinforcing elements which are advantageously metallic and extensible, referred to as elastic. It can also comprise a layer of metal threads or cords having a low extensibility forming, with the circumferential direction, an angle of between 45° and 90°, this “triangulation” ply being radially located between the carcass reinforcement and the first “working” crown ply, which are formed of parallel threads or cords exhibiting angles at most equal to 45° in absolute value. The triangulation ply forms, with at least the said working ply, a triangulated reinforcement which exhibits, under the various stresses to which it is subjected, few deformations, the triangulation ply having the essential role of absorbing the transverse compressive loads to which all the reinforcing elements in the region of the crown of the tire are subjected.

Cords are said to be inextensible when the said cords exhibit, under a tensile force equal to 10% of the breaking force, a relative elongation at most equal to 0.2%.

Cords are said to be elastic when the said cords exhibit, under a tensile force equal to the breaking load, a relative elongation at least equal to 3% with a maximum tangent modulus of less than 150 GPa.

Circumferential reinforcing elements are reinforcing elements which form, with the circumferential direction, angles within the range +2.5°, −2.5° in the vicinity of 0°.

The circumferential direction of the tire, or longitudinal direction, is the direction corresponding to the periphery of the tire and defined by the direction in which the tire runs.

The transverse or axial direction of the tire is parallel to the axis of rotation of the tire.

The radial direction is a direction which intersects the axis of rotation of the tire and is perpendicular thereto.

The axis of rotation of the tire is the axis around which it revolves in normal use.

A radial or meridian plane is a plane which contains the axis of rotation of the tire.

The circumferential median plane, or equatorial plane, is a plane perpendicular to the axis of rotation of the tire and which divides the tire into two halves.

The term “modulus of elasticity” of a rubber mixture is understood to mean a secant modulus of extension at 10% deformation and at ambient temperature.

As regards the rubber compositions, the measurements of modulus are carried out in tension according to Standard AFNOR-NFT-46002 of September 1988: the nominal secant modulus (or apparent stress, in MPa) at 10% elongation is measured in second elongation (i.e., after an accommodation cycle) (normal conditions of temperature and hygrometry according to Standard AFNOR-NFT-40101 of December 1979).

Some current tires, referred to as “road” tires, are intended to run at high speed and over increasingly long journeys, as a result of the improvement in the road network and of the growth of the motorway network throughout the world. The combined conditions under which such a tire is called upon to run without any doubt makes possible an increase in the number of miles traveled, the wear on the tire being reduced; on the other hand, the endurance of the tire and in particular of the crown reinforcement is detrimentally affected.

This is because there exist stresses at the crown reinforcement and more particularly shear stresses between the crown layers, combined with a not insignificant rise in the operating temperature at the ends of the axially shortest crown layer, the consequence of which is the appearance and the propagation of cracks in the rubber at the said ends.

In order to improve the endurance of the crown reinforcement of the type of tire studied, solutions relating to the structure and quality of the layers and/or profiled elements of rubber mixtures which are positioned between and/or around the ends of plies and more particularly the ends of the axially shortest ply have already been introduced.

It is known in particular to introduce a layer of rubber mixture between the ends of the working layers in order to create a decoupling between the said ends in order to limit the shear stresses. Such decoupling layers must, however, exhibit a very good cohesion. Such layers of rubber mixtures are, for example, described in Patent Application WO 2004/076204.

Patent FR 1 389 428, in order to improve the resistance to deterioration of the rubber mixtures located in the vicinity of the crown reinforcement edges, recommends the use, in combination with a tread of low hysteresis, of a rubber profiled element covering at least the sides and the marginal edges of the crown reinforcement and consisting of a low-hysteresis rubber mixture.

Patent FR 2 222 232, in order to prevent separations between crown reinforcement plies, teaches coating the ends of the reinforcement in a rubber mat, the Shore A hardness of which is different from that of the tread surmounting the said reinforcement and greater than the Shore A hardness of the rubber mixture profiled element positioned between the edges of crown reinforcement plies and carcass reinforcement.

The tires thus produced make it possible effectively to improve the performance, in particular in terms of endurance.

Furthermore, it is known, in order to produce tires having a very broad tread or else in order to confer, on tires of a given dimension, higher load capabilities, to introduce a layer of circumferential reinforcing elements. Patent Application WO 99/24269 describes, for example, the presence of such a layer of circumferential reinforcing elements.

The layer of circumferential reinforcing elements is normally composed of at least one metal cord wound in order to form a turn, the angle at which it is laid with respect to the circumferential direction being less than 2.5°.

### SUMMARY

An aim of embodiments of the invention is to provide tires, the properties, in particular of endurance and wear, of which are retained, whatever the use, and the performance of which in terms of rolling resistance is improved, in order to contribute to a reduced consumption of fuel by the vehicles equipped with such tires.

This aim is achieved according to embodiments of the invention by a tire having a radial carcass reinforcement comprising a crown reinforcement formed of at least two working crown layers each formed of reinforcing elements inserted between two calendering layers of rubber mixture, crossed from one layer to the other while forming, with the circumferential direction, angles of between 10° and 45°, the crown reinforcement being topped radially by a tread, the said tread being joined to two beads via two sidewalls, the crown reinforcement comprising at least one layer of circumferential reinforcing elements, the tensile modulus of elasticity at 10% elongation of at least one calendering layer of at least one working crown layer being less than 8.5 MPa, the maximum tan(δ) value, denoted tan(δ)ₘₐₓ, of the said calendering being less than 0.100 and the said at least one calendering layer of at least one working crown layer being an elastomeric mixture based on natural rubber or on synthetic polyisoprene predominantly comprising cis-1,4 enchainments and optionally on at least one other diene elastomer, the natural rubber or the synthetic polyisoprene, in the case of a blend, being present at a predominant content with respect to the content of the other diene elastomer(s) used, and on a reinforcing filler consisting:
a) either of carbon black with a BET specific surface of greater than 60 m²/g,
   i. employed at a content of between 20 and 40 phr when the structural index of the black (COAN) is greater than 85,
   ii. employed at a content of between 20 and 50 phr when the structural index of the black (COAN) is less than 85,
b) or of carbon black with a BET specific surface of less than 60 m²/g, whatever its structural index, employed at a content of between 20 and 80 phr and preferably between 30 and 50 phr,
c) or of a white filler of silica and/or alumina type comprising SiOH and/or AlOH surface functional groups, selected from the group consisting of precipitated or fumed silicas, aluminas and aluminosilicates, or alternatively carbon blacks modified during or after the synthesis having a BET specific surface of between 130 and 260 m²/g and preferably greater than 150 m²/g, employed at a content of between 20 and 80 phr and preferably between 30 and 50 phr,
d) or of a blend of carbon black described in (a) and/or of carbon black described in (b) and/or a white filler described in (c), in which the overall content of filler is between 20 and 80 phr and preferably between 40 and 60 phr.

The BET specific surface measurement is carried out according to the Brunauer, Emmett and Teller method described in The Journal of the American Chemical Society, vol. 60, page 309, February 1938, corresponding to Standard NFT 45007 of November 1987.

The structural index of the black, COAN (Compressed Oil Absorption Number), is measured according to Standard ASTM D3493.

The loss factor tan(δ) is a dynamic property of the layer of rubber mixture. It is measured on a viscosity analyzer (Metravib VA4000) according to Standard ASTM D 5992-96. The response of a sample of vulcanized composition (cylindrical test specimen with a thickness of 4 mm and with a cross section of 400 mm²), subjected to a simple alternating sinusoidal shear stress, at a frequency of 10 Hz, at a temperature of 100° C., is recorded. A strain amplitude sweep is carried out from 0.1% to 50% (outward cycle) and then from 50% to 1% (return cycle). For the return cycle, the maximum value of tan(δ) observed, denoted tan(δ)ₘₐₓ, is indicated.

The rolling resistance is the resistance which appears when the tire rolls. It is represented by the hysteresis losses related to the deformation of the tire during a revolution. The frequency values related to the revolution of the tire correspond to tan(δ) values measured between 30 and 100° C. The tan(δ) value at 100° C. thus corresponds to an indicator of the rolling resistance of the tire when rolling.

It is also possible to estimate the rolling resistance by the measurement of the losses in energy by rebound of the samples having energy applied at temperatures of 60° C. and expressed as a percentage.

Advantageously, according to the embodiments of the invention, the loss at 60° C., denoted L60, of the layer of rubber mixture C is less than 20%.

According to a preferred embodiment of the invention, the tensile modulus of elasticity at 10% elongation of the calendering layers of the said at least two working crown layers is less than 8.5 MPa and the tan(δ)ₘₐₓ value of the calendering layers of the said at least two working crown layers is less than 0.100.

The use of such mixtures, the moduli of elasticity of which are less than 8.5 MPa and the tan(δ)ₘₐₓ value of which is less than 0.100, will make it possible to improve the properties of the tire as regards rolling resistance, while retaining satisfactory endurance properties.

In the case of use of clear filler or white filler, it is necessary to use a coupling and/or covering agent chosen from the agents known to a person skilled in the art. Mention may be made, as examples of preferred coupling agents, of alkoxysilane sulphides of the bis(3-trialkoxysilylpropyl)polysulphide type and among these in particular of bis(3-triethoxysilylpropyl)tetrasulphide, sold by Degussa under the name Si69 for the pure liquid product and the name X50S for the solid product (50/50 by weight blend with N330 black). Mention may be made, as examples of covering agents, of a fatty alcohol, an alkylalkoxysilane, such as a hexadecyltrimethoxysilane or hexadecyltriethoxysilane respectively sold by Degussa under the names Si116 and Si216, diphenylguanidine, a polyethylene glycol or a silicone oil, optionally modified by means of OH or alkoxy functional groups. The covering and/or coupling agent is used in a ratio by weight, with respect to the filler, ≧ than 1/100 and ≦ than 20/100, and preferably of between 2/100 and 15/100, when the clear filler represents all of the reinforcing filler, and of between 1/100 and 20/100, when the reinforcing filler consists of a blend of carbon black and clear filler.

Mention may be made, as other examples of reinforcing fillers having the morphology and the SiOH and/or AlOH surface functional groups of the materials of silica and/or alumina type described above and which can be used according to the invention as partial or complete replacement for these, of carbon blacks modified either during the synthesis, by addition, to the feed oil of the furnace, of a silicon and/or aluminium compound, or after the synthesis, by adding an acid to an aqueous suspension of carbon black in a sodium silicate and/or aluminate solution, so as to at least partially cover the surface of the carbon black with SiOH and/or AlOH functional groups. Mention may be made, as nonlimiting examples of carbon-based fillers of this type with SiOH and/or AlOH functional groups at the surface, of the fillers of CSDP type described in Conference No. 24 of the ACS Meeting, Rubber Division, Anaheim, Calif., 6-9 May 1997, and also those of Patent Application EP-A-0 799 854.

When a clear filler is used as sole reinforcing filler, the hysteresis and cohesive properties are obtained by using a precipitated or fumed silica, or else a precipitated alumina or alternatively an aluminosilicate having a BET specific surface of between 30 and 260 m²/g. Mention may be made, as nonlimiting examples of filler of this type, of the silicas KS404 from Akzo, Ultrasil VN2 or VN3 and BV3370GR from Degussa, Zeopol 8745 from Huber, Zeosil 175 MP or Zeosil 1165 MP from Rhodia, HI-SIL 2000 from PPG, and the like.

Mention may be made, among the diene elastomers which can be used as a blend with natural rubber or a synthetic polyisoprene predominantly comprising cis-1,4 enchainments, of a polybutadiene (BR) preferably predominantly comprising cis-1,4 enchainments, a solution or emulsion stirene/butadiene copolymer (SBR), a butadiene/isoprene copolymer (BIR) or alternatively a stirene/butadiene/isoprene terpolymer (SBIR). These elastomers can be elastomers modified during polymerization or after polymerization by means of branching agents, such as a divinylbenzene, or star-branching agents, such as carbonates, halotins or halosilicons, or alternatively by means of functionalization agents resulting in a grafting, to the chain or at the chain end, of oxygen-comprising carbonyl or carboxyl functional groups or else of an amine functional group, such as, for example, by the action of dimethylaminobenzophenone or diethylaminobenzophenone. In the case of blends of natural rubber or synthetic polyisoprene predominantly comprising cis-1,4 enchainments with one or more of the diene elastomers mentioned above, the natural rubber or the synthetic polyisoprene is preferably used at a predominant content and more preferably at a content of greater than 70 phr.

According to this preferred embodiment of the invention, a lower modulus of elasticity is generally accompanied by a lower viscous modulus G″, this change proving to be favorable to a reduction in the rolling resistance of the tire.

Usually, the tensile moduli of elasticity at 10% elongation of the calenderings of the crown layers are greater than 8.5 MPa and most often greater than 10 MPa. Such moduli of elasticity are required in particular in order to make it possible to limit the compressing of the reinforcing elements of the working crown layers, in particular when the vehicle is following a tortuous route, during maneuvers in car parks or else when crossing roundabouts. This is because the shearing actions along the axial direction which act on the tread in the region of the contact surface with the ground result in the compressing of the reinforcing elements of a working crown layer.

The inventors have been able to demonstrate that the layer of circumferential reinforcing elements allows lower moduli of elasticity of the rubber mixtures of the calendering layers of the working crown layers to be chosen without harming the properties of endurance of the tire as a result of the compressing of the reinforcing elements of the said working crown layers as described above.

The inventors have also been able to demonstrate that the cohesion of the calendering layers of the working crown layers, when it exhibits a tensile modulus of elasticity at 10% elongation of less than 8.5 MPa, remains satisfactory.

According to the embodiments of the invention, a cohesive rubber mixture is a rubber mixture which is in particular robust towards cracking. The cohesion of a mixture is thus evaluated by a fatigue cracking test carried out on a “PS” (pure shear) test specimen. It consists in determining, after notching the test specimen, the crack propagation rate “PR” (nm/cycle) as a function of the energy restitution level “E” (J/m²). The experimental domain covered by the measurement is within the range −20° C. and +150° C. in temperature, with an air or nitrogen atmosphere. The stress on the test specimen is an applied dynamic displacement with an amplitude of between 0.1 mm and 10 mm in the form of a pulse-type stress (tangent “haversine” signal) with a rest period equal to the duration of the pulse; the frequency of the signal is of the order of 10 Hz on average.

The measurement comprises 3 parts:
An accommodation of the “PS” test specimen, of 1000 cycles at 27% deformation.
An energy characterization in order to determine the law “E”=f (deformation). The energy restitution level “E” is equal to W0*h0, with W0=energy supplied to the material per cycle and per unit of volume and h0=initial height of the test specimen. The “force/displacement” data acquired is made use of to thus give the relationship between “E” and the amplitude of the stress.
The cracking measurement, after notching the “PS” test specimen. The data collected result in the determination of the crack propagation rate “PR” as a function of the applied stress level “E”.

The inventors have in particular demonstrated that the presence of at least one layer of circumferential reinforcing elements contributes to a reduced change in the cohesion of the calendering layers of the working crown layers. This is because the designs of more conventional tires comprising in particular calendering layers of the working crown layers with tensile moduli of elasticity at 10% elongation of greater than 8.5 MPa result in a change in the cohesion of the said calendering layers of the working crown layers, the cohesion tending to become weaker. The inventors find that the presence of at least one layer of circumferential reinforcing elements which contributes to limiting the compressing of the reinforcing elements of the working crown layers, in particular when the vehicle is following a tortuous route, and in addition limits the increases in temperature results in a slight change in the cohesion of the calendering layers. The inventors thus consider that the cohesion of the calendering layers of the working crown layers, which is lower than that which exists in the designs of more conventional tires, is satisfactory in the design of the tire according to invention.

The inventors have also demonstrated that the combination of a layer of circumferential reinforcing elements and of tensile moduli of elasticity at 10% elongation of the calenderings of the crown layers of less than 8.5 MPa makes it possible to retain a satisfactory ply-steer effect.

The ply-steer effect corresponds to the appearance of a transverse thrust at zero cornering as a result of the structure of the tire and in particular of the presence of working crown layers of reinforcing elements forming an angle with the circumferential direction of between 10 and 45°, which are the cause of the said thrust during their deformations as a result of the passage through the contact area formed by the crushing of the tire on the ground when the tire is rolling.

The inventors have thus demonstrated that the ply-steer effect, which is modified as a result of the presence of a layer of circumferential reinforcing elements, will experience an alleviation in its variation as a result of the choice of calendering mixtures of the working layers with reduced moduli of elasticity. This is because the transverse thrust increases as a result of the presence of a layer of circumferential reinforcing elements, with respect to one and the same tire without the said layer of circumferential reinforcing elements, and this increase is alleviated by a choice of calendering mixtures of the working layers with moduli of elasticity which are reduced with respect to those normally used.

According to an advantageous implementation of the invention, the said reinforcing elements of at least one working crown layer are saturated layered cords, at least one inner liner being sheathed with a layer consisting of a polymeric composition, such as a non-crosslinkable, crosslinkable or crosslinked rubber composition, preferably based on at least one diene elastomer.

“Layered” or “multilayer” cords are cords consisting of a central core and of one or more virtually concentric layers of yarns or threads arranged around this central core.

According to the embodiments of the invention, a saturated layer of a layered cord is a layer consisting of threads in which there does not exist sufficient space to add thereto at least one additional thread.

The inventors have been able to demonstrate that the presence of the cords as just described as reinforcing elements of working crown layers makes it possible to contribute to a better performance in terms of endurance.

This is because it is apparent, as explained above, that the rubber mixtures of the calenderings of the working layers make it possible to reduce the rolling resistance of the tire. This is reflected by a fall in the temperatures of these rubber mixtures when the tire is used, which can result in reduced protection of the reinforcing elements with regard to oxidation phenomena in some cases of use of the tire. This is because the properties of the rubber mixtures relating to the blocking of the oxygen decline with temperature, and the presence of oxygen can result in a gradual deterioration in the mechanical properties of the cords, for the most severe rolling conditions, and can detrimentally affect the lifetime of these cords.

The presence of the rubber sheath within the cords described above will compensate for this possible risk of oxidation of the reinforcing elements, the sheath contributing to the blocking of the oxygen.

The expression “composition based on at least one diene elastomer” is understood to mean, in a known way, that the composition predominantly comprises (i.e., according to a fraction by weight of greater than 50%) this or these diene elastomers.

It should be noted that the sheath according to embodiments of the invention extends continuously around the layer which it covers (that is to say that this sheath is continuous in the “orthoradial” direction of the cord, which is perpendicular to its radius), so as to form a continuous sleeve having a transverse cross section which is advantageously virtually circular.

It should also be noted that the rubber composition of this sheath can be crosslinkable or crosslinked, that is to say that it comprises, by definition, a suitable crosslinking system for making possible the crosslinking of the composition during the curing thereof (i.e., the curing thereof and not the melting thereof); thus, this rubber composition can be described as infusible, owing to the fact that it cannot be melted by heating at any temperature whatever.

A “diene” elastomer or rubber is understood, in a known way, to mean an elastomer resulting at least in part (i.e., a homopolymer or a copolymer) from diene monomers (monomers bearing two conjugated or non-conjugated carbon-carbon double bonds).

Preferably, the system for crosslinking the rubber sheath is a “vulcanization” system, that is to say a system based on sulphur (or on a sulphur-donating agent) and on a primary vulcanization accelerator. Additional to this base vulcanization system may be various known secondary vulcanization accelerators or vulcanization activators.

The rubber composition of the sheath according to the invention can comprise, in addition to the said crosslinking system, all the normal ingredients which can be used in rubber compositions for tires, such as reinforcing fillers based on carbon black and/or on a reinforcing inorganic filler, such as silica, anti-ageing agents, for example antioxidants, extending oils, plasticizers or agents which promote the processing of compositions in the raw state, methylene acceptors and donors, resins, bismaleimides, known adhesion-promoting systems of the “RFS” (resorcinol/formaldehyde/silica) type or metal salts, in particular cobalt salts.

Preferably, the composition of this sheath is chosen to be identical to the composition used for the calendering layer of the working crown layer which the cords are intended to reinforce. Thus, there is no problem of possible incompatibility between the respective materials of the sheath and of the rubber matrix.

According to an alternative form of the invention, the said cords of at least one working crown layer are layered cords of [L+M] construction, comprising a first layer C1 having L threads of diameter d₁ wound together in a helix according to a pitch p₁ with L ranging from 1 to 4, surrounded by at least one intermediate layer C2 having M threads of diameter d₂ wound together in a helix according to a pitch p₂ with M ranging from 3 to 12, a sheath composed of a non-crosslinkable, crosslinkable or crosslinked rubber composition based on at least one diene elastomer covering, in the construction, the said first layer C1.

Preferably, the diameter of the threads of the first layer of the inner layer (C1) is between 0.10 and 0.5 mm and the diameter of the threads of the outer layer (C2) is between 0.10 and 0.5 mm.

More preferably, the winding helix pitch of the said threads of the outer layer (C2) is between 8 and 25 mm.

Within the meaning of the disclosure, the helix pitch represents the length, measured parallel to the axis of the cord, at the end of which a thread having this pitch makes one complete turn around the axis of the cord; thus, if the axis is sectioned by two planes perpendicular to the said axis and separated by a length equal to the pitch of a thread of a constituent layer of the cord, the axis of this thread has, in both these planes, the same position on the two circles corresponding to the layer of the thread under consideration.

Advantageously, the cord exhibits one and more preferably still all of the following characteristics, which is confirmed:
the layer C2 is a saturated layer, that is to say that there does not exist sufficient space in this layer to add thereto at least one (N+1)th thread of diameter d₂, N then representing the maximum number of threads which can be wound as a layer around the layer C1;
the rubber sheath in addition covers the inner layer C1 and/or separates the paired adjacent threads of the outer layer C2;
the rubber sheath covers virtually the radially inner half-circumference of each thread of the layer C2, so that it separates the adjacent paired threads of this layer C2.

Preferably, the rubber sheath exhibits a mean thickness ranging from 0.010 mm to 0.040 mm.

Generally, the said cords according to embodiments of the invention can be produced with metal threads of any type, in particular made of steel, for example threads made of carbon steel and/or threads made of stainless steel. Use is preferably made of carbon steel but it is, of course, possible to use other steels or other alloys.

When a carbon steel is used, its carbon content (% by weight of steel) is preferably between 0.1% and 1.2%, more preferably between 0.4% and 1.0%; these contents represent a good compromise between the mechanical properties required for the tire and the feasibility of the thread. It should be noted that a carbon content of between 0.5% and 0.6% renders such steels finally less expensive as they are easier to draw. Another advantageous embodiment of the invention can also consist, depending on the applications targeted, in using steels having a low carbon content, for example of between 0.2% and 0.5%, due in particular to a lower cost and to a greater ease of drawing.

The said cords according to embodiments of the invention can be obtained according to various techniques known to a person skilled in the art, for example in two stages, first of all by sheathing the core or layers C1 via an extrusion head, which stage is followed, in a second step, by a final operation in which the remaining threads M (layer C2) are cabled or twisted around the layer C1 thus sheathed. The problem of bonding in the raw state posed by the rubber sheath during the optional intermediate winding and unwinding operations can be solved in a way known to a person skilled in the art, for example by the use of an interposed plastic film.

Such cords of at least one working crown layer are, for example, chosen from the cords described in Patent Applications WO 2006/013077 and WO 2009/083212.

According to an advantageous embodiment of the invention, the axially widest working crown layer is radially interior to the other working crown layers.

According to an advantageous alternative embodiment of the invention, the layer of circumferential reinforcing elements exhibits an axial width of greater than 0.5×S.

S is the axial maximum width of the tire, when the latter is fitted to its service rim and inflated to its recommended pressure.

The axial widths of the layers of reinforcing elements are measured on a transverse cross section of a tire, the tire thus being in a non-inflated state.

According to a preferred implementation of the invention, at least two working crown layers exhibit different axial widths, the difference between the axial width of the axially widest working crown layer and the axial width of the axially narrowest working crown layer being between 10 and 30 mm.

According to a preferred embodiment of the invention, the layer of circumferential reinforcing elements is positioned radially between two working crown layers.

According to this embodiment of the invention, the layer of circumferential reinforcing elements makes it possible to more significantly limit the compressing of the reinforcing elements of the carcass reinforcement than a similar layer positioned radially outside the working layers. It is preferably radially separated from the carcass reinforcement by at least one working layer, so as to limit the stresses of the said reinforcing elements and to not excessively fatigue them.

Advantageously again according to embodiments of the invention, the axial widths of the working crown layers radially adjacent to the layer of circumferential reinforcing elements are greater than the axial width of the said layer of circumferential reinforcing elements and, preferably, the said working crown layers adjacent to the layer of circumferential reinforcing elements are on either side of the equatorial plane and, in the immediate axial extension of the layer of circumferential reinforcing elements, coupled over an axial width, in order to be subsequently decoupled by the said layer C of rubber mixture at least over the remainder of the width common to the said two working layers.

The presence of such couplings between the working crown layers adjacent to the layer of circumferential reinforcing elements makes it possible to decrease the tensile stresses acting on the axially outermost circumferential elements located closest to the coupling.

According to an advantageous embodiment of the invention, the reinforcing elements of at least one layer of circumferential reinforcing elements are metal reinforcing elements exhibiting a secant modulus at 0.7% elongation of between 10 and 120 GPa and a maximum tangent modulus of less than 150 GPa.

According to a preferred implementation, the secant modulus of the reinforcing elements at 0.7% elongation is less than 100 GPa and greater than 20 GPa, preferably between 30 and 90 GPa and more preferably less than 80 GPa.

Preferably again, the maximum tangent modulus of the reinforcing elements is less than 130 GPa and more preferably less than 120 GPa.

The moduli expressed above are measured on a curve of tensile stress as a function of the elongation determined with a preload of 20 MPa corrected for the cross section of metal of the reinforcing element, the tensile stress corresponding to a measured tension corrected for the cross section of metal of the reinforcing element.

The moduli of the same reinforcing elements can be measured on a curve of tensile stress as a function of the elongation determined with a preload of 10 MPa corrected for the overall cross section of the reinforcing element, the tensile stress corresponding to a measured tension corrected for the overall cross section of the reinforcing element. The overall cross section of the reinforcing element is the cross section of a composite element consisting of metal and rubber, the latter having in particular penetrated the reinforcing element during the phase of curing the tire.

According to this formulation relating to the overall cross section of the reinforcing element, the reinforcing elements of the axially outer parts and the central part of at least one layer of circumferential reinforcing elements are metal reinforcing elements exhibiting a secant modulus at 0.7% elongation of between 5 and 60 GPa and a maximum tangent modulus of less than 75 GPa.

According to a preferred implementation, the secant modulus of the reinforcing elements at 0.7% elongation is less than 50 GPa and greater than 10 GPa, preferably between 15 and 45 GPa and more preferably less than 40 GPa.

Preferably again, the maximum tangent modulus of the reinforcing elements is less than 65 GPa and more preferably less than 60 GPa.

According to a preferred embodiment, the reinforcing elements of at least one layer of circumferential reinforcing elements are metal reinforcing elements exhibiting a curve of tensile stress as a function of the relative elongation having low slopes for the low elongations and a substantially constant and high slope for the greater elongations. Such reinforcing elements of the additional ply are normally known as “bimodulus” elements.

According to a preferred implementation of the invention, the substantially constant and high slope appears from a relative elongation of between 0.1% and 0.5%.

The various characteristics of the reinforcing elements set out above are measured on reinforcing elements withdrawn from tires.

Reinforcing elements more particularly suited to the production of at least one layer of circumferential reinforcing elements according to the invention are, for example, assemblies of formula 21.23, the construction of which is 3×(0.26+6×0.23) 4.4/6.6 SS; this stranded cord consists of 21 elementary threads of formula 3×(1+6), with three strands twisted together and each consisting of seven threads, one thread forming a central core of diameter equal to 26/100 mm and six wound threads of diameter equal to 23/100 mm. Such a cord exhibits a secant modulus at 0.7% equal to 45 GPa and a maximum tangent modulus equal to 98 GPa, these being measured on a curve of tensile stress as a function of the elongation determined with a preload of 20 MPa corrected for the cross section of metal of the reinforcing element, the tensile stress corresponding to a measured tension corrected for the cross section of metal of the reinforcing element. On a curve of tensile stress as a function of the elongation determined with a preload of 10 MPa corrected for the overall cross section of the reinforcing element, the tensile stress corresponding to a measured tension corrected for the overall cross section of the reinforcing element, this cord of formula 21.23 exhibits a secant modulus at 0.7% equal to 23 GPa and a maximum tangent modulus equal to 49 GPa.

Likewise, another example of reinforcing elements is an assembly of formula 21.28, the construction of which is 3×(0.32+6×0.28) 6.2/9.3 SS. This cord exhibits a secant modulus at 0.7% equal to 56 GPa and a maximum tangent modulus equal to 102 GPa, these being measured on a curve of tensile stress as a function of the elongation determined with a preload of 20 MPa corrected for the cross section of metal of the reinforcing element, the tensile stress corresponding to a measured tension corrected for the cross section of metal of the reinforcing element. On a curve of tensile stress as a function of the elongation determined with a preload of 10 MPa corrected for the overall cross section of the reinforcing element, the tensile stress corresponding to a measured tension corrected for the overall cross section of the reinforcing element, this cord of formula 21.28 exhibits a secant modulus at 0.7% equal to 27 GPa and a maximum tangent modulus equal to 49 GPa.

The use of such reinforcing elements in at least one layer of circumferential reinforcing elements makes it possible in particular to retain satisfactory stiffnesses of the layer, including after the shaping and curing stages in conventional manufacturing processes.

According to a second embodiment of the invention, the circumferential reinforcing elements can be formed of inextensible metal elements cut so as to form sections having a length far smaller than the circumference of the shortest layer but preferably greater than 0.1 times the said circumference, the cuts between sections being axially offset with respect to one another. Preferably again, the tensile modulus of elasticity per unit of width of the additional layer is less than the tensile modulus of elasticity, measured under the same conditions, of the most extensible working crown layer. Such an embodiment makes it possible to confer, in a simple way, on the layer of circumferential reinforcing elements, a modulus which can be easily adjusted (by the choice of the intervals between sections of one and the same row) but which in all cases is lower than the modulus of the layer consisting of the same metal elements but with the latter being continuous, the modulus of the additional layer being measured on a vulcanized layer of cut elements which has been withdrawn from the tire.

According to a third embodiment of the invention, the circumferential reinforcing elements are undulating metal elements, the ratio a/λ of the undulation amplitude to the wavelength being at most equal to 0.09. Preferably, the tensile modulus of elasticity per unit of width of the additional layer is less than the tensile modulus of elasticity, measured under the same conditions, of the most extensible working crown layer.

The metal elements are preferably steel cords.

According to a preferred embodiment of the invention, the reinforcing elements of the working crown layers are inextensible metal cords.

The invention advantageously also provides, in order to reduce the tensile stresses acting on the axially outermost circumferential elements, for the angle formed by the reinforcing elements of the working crown layers with the circumferential direction to be less than 30° and preferably less than 25°.

According to another advantageous alternative form of the invention, the working crown layers comprise reinforcing elements, crossed from one ply to the other, forming, with the circumferential direction, angles which can vary along the axial direction, the said angles being greater on the axially outer edges of the layers of reinforcing elements, with respect to the angles of the said elements measured at the level of the circumferential median plane. Such an implementation of the invention makes it possible to increase the circumferential stiffness in certain regions and, on the contrary, to reduce it in other regions, in particular in order to reduce the compressing of the carcass reinforcement.

A preferred embodiment of the invention also provides for the crown reinforcement to be supplemented radially on the outside by at least one additional layer, known as protective layer, of “elastic” reinforcing elements, which are oriented, with respect to the circumferential direction, with an angle of between 10° and 45° and in the same direction as the angle formed by the inextensible elements of the working layer radially adjacent to it.

The protective layer can have an axial width smaller than the axial width of the narrowest working layer. The said protective layer can also have an axial width greater than the axial width of the narrowest working layer, such that it overlaps the edges of the narrowest working layer and, when it is the layer radially above which is narrowest, such that it is coupled, in the axial extension of the additional reinforcement, with the widest working crown layer over an axial width in order thereafter, axially on the outside, to be decoupled from the said widest working layer by profiled elements having a thickness at least equal to 2 mm. The protective layer formed of elastic reinforcing elements can, in the abovementioned case, on the one hand be optionally decoupled from the edges of the said narrowest working layer by profiled elements having a thickness substantially less than the thickness of the profiled elements separating the edges of the two working layers and, on the other hand, have an axial width less than or greater than the axial width of the widest crown layer.

According to any one of the embodiments of the invention mentioned above, the crown reinforcement can also be supplemented, radially on the inside between the carcass reinforcement and the radially inner working layer closest to the said carcass reinforcement, by a triangulation layer of inextensible metal reinforcing elements made of steel forming, with the circumferential direction, an angle greater than 60° and in the same direction as that of the angle formed by the reinforcing elements of the layer radially closest to the carcass reinforcement.

The tire according to the embodiments of the invention as just described thus exhibits an improved rolling resistance in comparison with conventional tires while retaining a comparable performance in terms of endurance and wear.

In addition, the lower moduli of elasticity of the rubber mixtures of the calenderings of the working crown layers make it possible to render the crown of the tire flexible and to thus limit the risks of attacks on the crown and of corrosion of the reinforcing elements of the crown reinforcement layers when, for example, stones are retained in the pattern bottom areas.

### BRIEF DESCRIPTION OF THE DRAWINGS

Other advantageous details and characteristics of embodiments of the invention will emerge below from the description of the implementational examples of the invention, with reference to FIGS. 1 and 2, which represent:

FIG. 1, a meridional view of a diagram of a tire according to a first embodiment of the invention,

FIG. 2, a meridional view of a diagram of a tire according to a second embodiment of the invention.

### DETAILED DESCRIPTION OF SPECIFIC EMBODIMENTS

The figures are not represented to scale in order to make them easier to understand. The figures represent only a half-view of a tire, which extends symmetrically with respect to the axis XX′, which represents the circumferential median plane, or equatorial plane, of a tire.

In FIG. 1, the tire 1, of dimension 315/70 R 22.5, has an aspect ratio H/S equal to 0.70, H being the height of the tire 1 on its mounting rim and S being its maximum axial width. The said tire 1 comprises a radial carcass reinforcement 2 anchored in two beads, not represented in the figure. The carcass reinforcement is formed of a single layer of metal cords. This carcass reinforcement 2 is hooped by a crown reinforcement 4 formed radially, from the inside to the outside:
of a first working layer 41 formed of non-hooped inextensible metal cords 9.28 which are continuous over the entire width of the ply and which are oriented with an angle equal to 24°,
of a layer of circumferential reinforcing elements 42 which is formed of metal cords made of steel 21×23, of “bimodulus” type,
of a second working layer 43 formed of non-hooped inextensible metal cords 9.28 which are continuous over the entire width of the ply, which are oriented with an angle equal to 24° and which are crossed with the metal cords of the layer 41,
of a protective layer 44 formed of elastic metal cords 6.35.

The crown reinforcement is itself topped by a tread 6.

The maximum axial width S of the tire is equal to 317 mm.

The axial width L₄₁ of the first working layer 41 is equal to 252 mm.

The axial width L₄₃ of the second working layer 43 is equal to 232 mm. The difference between the widths L₄₁ and L₄₃ is equal to 15 mm.

With regard to the axial width L₄₂ of the layer of circumferential reinforcing elements 42, it is equal to 194 mm.

The final crown ply 44, referred to as protective ply, has a width L₄₄ equal to 124 mm.

In accordance with the embodiments of the invention, the tensile modulus of elasticity at 10% elongation of the calendering layers of each of the working layers 41 and 43 is equal to 6 MPa.

In FIG. 2, the tire 1 differs from that represented in FIG. 1 in that the two working layers 41 and 43 are, on each side of the equatorial plane and axially in the extension of the layer of circumferential reinforcing elements 42, coupled over an axial width 1: the cords of the first working layer 41 and the cords of the second working layer 43, over the axial coupling width 1 of the two layers, are separated radially from one another by a rubber layer, the thickness of which is minimal and corresponds to twice the thickness of the rubber calendering layer of the non-hooped metal cords 9.28 of which each working layer 41, 43, is formed, i.e. 0.8 mm. Over the remaining width common to the two working layers, the two working layers 41, 43 are separated by a layer of rubber mixture.

Tests have been carried out with different tires prepared according to embodiments of the invention in accordance with the representation of FIG. 1 and compared with a reference tire T1 not comprising layers of circumferential reinforcing elements, for which the tensile moduli of elasticity at 10% elongation of the calenderings of the working crown layers are greater than 8.5 MPa and for which the tan(δ)ₘₐₓ values of the calenderings of the working crown layers are greater than 0.100.

The various mixtures used are listed below, the tensile modulus of elasticity at 10% elongation and the tan(δ)ₘₐₓ and L60 values being expressed for each.

| | Mixture R1 | Mixture 1 | Mixture 2 | Mixture 3 | Mixture 4 | Mixture 5 |
|---|---|---|---|---|---|---|
| NR | 100 | 100 | 100 | 100 | 100 | 100 |
| Black N347 | 52 | | 33 | | | |
| Black N683 | | | | | 44 | 30 |
| Black N326 | | 47 | | | | |
| Silica 165G | | | | 46 | | |
| Antioxidant (6PPD) | 1 | 1.5 | 1 | 2 | 1 | 1 |
| Stearic acid | 0.65 | 0.9 | 0.65 | 1 | 0.65 | 0.65 |
| Zinc oxide | 9.3 | 7.5 | 9.3 | 8 | 9.3 | 9.3 |
| Cobalt salt (CoAcac) | 1.12 | 1.12 | 1.12 | 1.1 | 1.12 | 1.12 |
| Cobalt salt | | | | | | |
| (CoAbietate) | | | | | | |
| Silane-on-black | | | | 8.3 | | |
| Sulphur | 6.1 | 4.5 | 6.1 | 4.8 | 6.1 | 6.1 |
| Accelerator DCBS | 0.93 | 0.8 | 0.93 | | 0.93 | 0.93 |
| Accelerator TBBS | | | | 1.01 | | |
| Coaccelerator DPG | | | | 1.1 | | |
| Retarder CTP PVI | 0.25 | 0.15 | 0.25 | 0.2 | 0.25 | 0.25 |
| M₁₀ (MPa) | 10.4 | 5.99 | 5.56 | 7.25 | 6.16 | 4.4 |
| tan(δ)ₘₐₓ | 0.130 | 0.099 | 0.074 | 0.063 | 0.056 | 0.030 |
| L60 (%) | 22.9 | 18.7 | 14.9 | 13.3 | 12.2 | 8.5 |

The values of the constituents are expressed in phr (parts by weight per hundred parts of elastomers).

As regards the reference tire T1, the calenderings of the working layers are composed of the mixture R1.

Different tires according to embodiments of the invention were tested, the calenderings of the working layers being composed of the mixtures 1 to 5.

First endurance tests were carried out on a test machine which made each of the tires run in a straight line at a speed equal to the maximum speed index prescribed for the said tire under an initial load of 4000 kg which was gradually increased in order to reduce the duration of the test.

Other endurance tests were carried out on a test machine which cyclically applies a transverse load and a dynamic overload to the tires. The tests were carried out for the tires according to embodiments of the invention with conditions identical to those applied to the reference tires.

The tests thus carried out showed that the distances traveled during each of these tests are substantially identical for the tires according to embodiments of the invention and the reference tires. It is thus apparent that the tires according to embodiments of the invention exhibit a performance in terms of endurance which is substantially equivalent to that of the reference tires.

Other running tests were carried out on non-bituminous surfaces consisting of stones particularly aggressive towards the treads of the tires.

The latter tests showed that, after identical distances traveled, the tires according to embodiments of the invention exhibit fewer and less significant detrimental changes than those of the reference tires.

These tests show in particular that the design of the tires according to embodiments of the invention allows a decrease in the modulus of elasticity of the calenderings of the working crown layers without adversely affecting the endurance performance when a layer of circumferential reinforcing elements is present.

Furthermore, rolling resistance measurements were carried out. These measurements related to a first reference tire T1 as described above, to a second reference tire T2 identical to the above and additionally comprising a layer of circumferential reinforcing elements identical to that of the tires according to embodiments of the invention and to a tire I1 in accordance with the invention, the calendering layers of the working crown layers of which are composed of the mixture 1.

The results of the measurements are presented in the following table; they are expressed in kg/t, a value of 100 being assigned to the tire T1.

| Tire T1 | Tire T2 | Tire I1 |
|---|---|---|
| 100 | 101 | 98 |

1. A tire comprising:
a radial carcass reinforcement comprising a crown reinforcement comprising:
at least two working crown layers each formed of reinforcing elements inserted between two calendering layers of rubber mixture, crossed from one layer to the other while forming, with a circumferential direction, angles of between 10° and 45°,
at least one layer of circumferential reinforcing elements, wherein the tensile modulus of elasticity at 10% elongation of at least one calendering layer of at least one working crown layer is less than 8.5 MPa and wherein,
the maximum tan(δ) value, denoted tan(δ)ₘₐₓ, of the at least one calendering layer of at least one working crown layer is less than 0.100 and wherein,
the at least one calendering layer of at least one working crown layer is an elastomeric mixture based on natural rubber or on synthetic polyisoprene predominantly comprising cis-1,4 enchainments and optionally on at least one other diene elastomer, the natural rubber or the synthetic polyisoprene, in the case of a blend, being present at a predominant content with respect to the content of the other diene elastomer(s) used, and on a reinforcing filler consisting:
a) either of carbon black with a BET specific surface of greater than 60 m²/g,
i. employed at a content of between 20 and 40 phr when the structural index of the carbon black using Compressed Oil Absorption Number (COAN) is greater than 85,
ii. employed at a content of between 20 and 50 phr when the structural index of the carbon black (COAN) is less than 85,
b) or of carbon black with a BET specific surface of less than 60 m²/g, whatever its structural index, employed at a content of between 20 and 80 phr,
c) or of a white filler of silica and/or alumina type comprising SiOH and/or AlOH surface functional groups, selected from the group consisting of precipitated or fumed silicas, aluminas and aluminosilicates, or alternatively carbon blacks modified during or after the synthesis having a BET specific surface of between 130 and 260 m²/g, employed at a content of between 20 and 80 phr,
d) or of a blend of carbon black described in (a) and/or of carbon black described in (b) and/or a white filler described in (c), in which the overall content of filler is between 20 and 80 phr;
a tread joined to two beads via two sidewalls, radially topping the crown reinforcement.

2. The tire according to claim 1, wherein the reinforcing elements of at least one working crown layer are saturated layered cords, at least one inner liner being sheathed with a layer consisting of a polymeric composition.

3. The tire according to claim 1, wherein the layer of circumferential reinforcing elements is positioned radially between two working crown layers.

4. The tire according to claim 1, wherein at least two working crown layers exhibit different axial widths, wherein the difference between an axial width of an axially widest working crown layer and an axial width of an axially narrowest working crown layer is between 10 and 30 mm.

5. The tire according to claim 4, wherein the axially widest working crown layer is radially interior to the other working crown layers.

6. The tire according to claim 4, wherein the axial widths of the working crown layers radially adjacent to the layer of circumferential reinforcing elements are greater than the axial width of the said layer of circumferential reinforcing elements.

7. The tire according to claim 6, wherein the working crown layers adjacent to the layer of circumferential reinforcing elements are on either side of the equatorial plane and, in the immediate axial extension of the layer of circumferential reinforcing elements, coupled over an axial width, in order to be subsequently decoupled by profiled elements of rubber mixture at least over the remainder of the width common to the said two working layers.

8. The tire according to claim 1, wherein the reinforcing elements of at least one layer of circumferential reinforcing elements are metal reinforcing elements exhibiting a secant modulus at 0.7% elongation of between 10 and 120 GPa and a maximum tangent modulus of less than 150 GPa.

9. The tire according to claim 1, wherein the reinforcing elements of the working crown layers are inextensible.

10. The tire according to claim 1, wherein the angle formed by the reinforcing elements of the working crown layers with the circumferential direction is less than 30°.

11. The tire according to claim 1, wherein the crown reinforcement is supplemented radially on the outside by at least one additional ply, known as protective ply, of “elastic” reinforcing elements, which are oriented, with respect to the circumferential direction, with an angle of between 10° and 45° and in the same direction as the angle formed by the inextensible elements of the working ply radially adjacent to it.

12. The tire according to claim 1, wherein the crown reinforcement additionally comprises a triangulation layer formed of metal reinforcing elements forming, with the circumferential direction, angles greater than 60°.
